(19) United States
(12) Patent Application Publication
(10) Pub. No.: US 2023/0047500 A1
(43) Pub. Date: Feb. 16, 2023

(54) INCLINATION CONTROL SYSTEM FOR TRACKED VEHICLE

(71) Applicant: MOVEX INNOVATION INC., Shawinigan (CA)

(72) Inventor: Yvan LAFONTAINE, Shawinigan (CA)

(21) Appl. No.: 17/797,325

(22) PCT Filed: Feb. 4, 2021
(86) PCT No.: PCT/CA2021/050120

§ 371 Date: Aug. 3, 2022

Related U.S. Application Data
(60) Provisional application No. 62/969,833, filed on Feb. 4, 2020.

(51) Int. Cl. B62D 55/075; G05D 1/08

(52) U.S. Cl. CPC B62D 55/075; G05D 1/0891

(57) ABSTRACT

A system for controlling a pitch of an endless track vehicle for driving the endless track vehicle in a given direction; monitoring a pitch angle of the endless track vehicle while moving along the given direction; and upon determining that the pitch angle is varying, controlling the driving of the endless track vehicle to control a rate of variation of the pitch angle of the endless track vehicle. The endless track vehicle may include a body defining a load bearing surface. Track(s) is rotatably mounted to the body to move the body. A motorization unit actuates the track(s). A drive system operates the motorization unit.

### CROSS REFERENCE TO RELATED APPLICATION

The present application claims the priority of U.S. Pat. Application No. 62/969,833, filed on Feb. 4, 2020, the content of which is incorporated herein by reference.

### TECHNICAL FIELD

The application relates to endless track vehicles such as unmanned endless track vehicles used to carry loads up inclined surfaces.

### BACKGROUND

Endless track vehicles are conveniently used to carry loads on various types of terrain. The endless track vehicles may often be unmanned and controlled by a remote operator. Such endless track vehicles may be known as buggies, carriers, robot vehicles, etc. One concern with such endless track vehicles is their relatively flat bottom surface that renders hazardous a transition between an inclined surface and a flat surface. For instance, when an unmanned endless track vehicle carries a load up a staircase, improper control of the endless track vehicle may result in too rapid of a variation about the pitch axis, especially with large loads. When large loads are involved, this may result in important impacts, which may damage the load, cause a sudden shift about a yaw axis of the vehicle and/or cause a rollover of the vehicle. Moreover, in other situations such endless track vehicles may carry loads on an uneven terrain, with a risk of rollover being present, especially in scenarios in which a load raises a center of gravity of the vehicle and load assembly.

### SUMMARY

In one aspect, there is provided a system for controlling a pitch of an endless track vehicle comprising: one or more processors; a non-transitory computer readable memory communicatively coupled to the processor of the drive system and comprising computer readable program instructions executable by the processor for: driving the endless track vehicle in a given direction; monitoring a pitch angle of the endless track vehicle while moving along the given direction; and upon determining that the pitch angle is varying, controlling the driving of the endless track vehicle to control a rate of variation of the pitch angle of the endless track vehicle.

Further in accordance with the aspect, for example, controlling the driving of the endless track vehicle includes decelerating a velocity of the endless track vehicle in the given direction.

Still further in accordance with the aspect, for example, controlling the driving of the endless track vehicle includes driving the endless track vehicle in a direction opposite to the given direction.

Still further in accordance with the aspect, for example, driving the endless track vehicle in a given direction includes driving the endless track vehicle along a stair case or landing of a stair case.

Still further in accordance with the aspect, for example, a position of the endless track vehicle relative to a transition is monitored between the stair case and the landing.

Still further in accordance with the aspect, for example, the driving of the endless track vehicle is controlled to decelerate the endless track vehicle when a distance from the transition is reached.

Still further in accordance with the aspect, for example, monitoring the position of the endless track vehicle is performed by ultrasound sensing.

Still further in accordance with the aspect, for example, a yaw of the endless track vehicle is monitored while moving along the given direction along the stair case.

Still further in accordance with the aspect, for example, upon determining that the yaw is varying, controlling the driving of the endless track vehicle to adjust the yaw of the endless track vehicle.

Still further in accordance with the aspect, for example, controlling the driving of the endless track vehicle to adjust the yaw of the endless track vehicle includes inducing a speed differential between two tracks of the endless track vehicle.

Still further in accordance with the aspect, for example, controlling the driving of the endless track vehicle to adjust the yaw of the endless track vehicle includes inducing a difference in direction of rotation between two tracks of the endless track vehicle.

Still further in accordance with the aspect, for example, a roll of the endless track vehicle is monitored while moving along the given direction.

Still further in accordance with the aspect, for example, upon determining that the roll of the endless track vehicle is at a threshold, controlling the driving of the endless track vehicle to decelerate the endless track vehicle.

Still further in accordance with the aspect, for example, upon determining that the roll of the endless track vehicle is at a threshold, controlling the driving of the endless track vehicle to limit a top velocity of the endless track vehicle.

Still further in accordance with the aspect, for example, the driving, the monitoring and the controlling of the driving are performed in an autonomous self-driving mode of the endless track vehicle.

Still further in accordance with the aspect, for example, the driving, the monitoring and the controlling of the driving are performed in overriding mode of the endless track vehicle to override operator commands.

Still further in accordance with the aspect, for example, the driving, the monitoring and the controlling of the driving are performed automatically.

Still further in accordance with the aspect, for example, at least one orientation sensor is provided.

Still further in accordance with the aspect, for example, the at least one orientation sensor includes at least one inertial sensor.

Still further in accordance with the aspect, for example, the at least one inertial sensor includes at least one accelerometer and/or at least one gyroscope.

Still further in accordance with the aspect, for example, at least one position sensor is provided.

Still further in accordance with the aspect, for example, the at least one position sensor is at least one ultrasound sensor device and/or at least one optical sensor.

In accordance with a further aspect, there is provided an endless track vehicle comprising: a body defining a load bearing surface; at least one track rotatably mounted to the body to move the body; a motorization unit to actuate the at least one track; a drive system to operate the motorization unit; and the system as above, the system collaborating with the drive system.

Still in accordance with the further aspect, for example, there are two of the at least one track.

Still in accordance with the further aspect, for example, the motorization unit includes a bidirectional motor for each of the at least one track

### DESCRIPTION OF THE DRAWINGS

Reference is now made to the accompanying figures in which:

FIG. 1A is a first perspective view of an unmanned endless track vehicle;

FIG. 1B is a second perspective view of the unmanned endless track vehicle;

FIG. 2 is a block diagram showing a drive system and a inclination control system as used with the endless track vehicle of FIGS. 1A and 1B;

FIG. 3A is a schematic view of the endless track vehicle of FIG. 1A or FIG. 1B moving up a staircase;

FIG. 3B is a schematic view of the endless track vehicle of FIG. 3A at the top of the stairs with involvement of the inclination control system of the present disclosure; and

FIG. 4 is a flowchart of a method for controlling a pitch of an endless track vehicle in accordance with a variant of the present disclosure.

### DETAILED DESCRIPTION

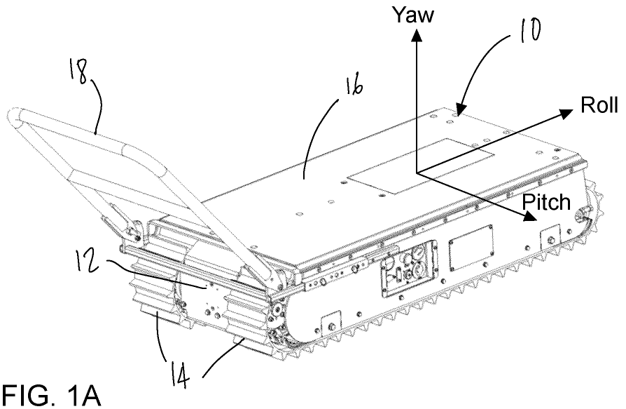

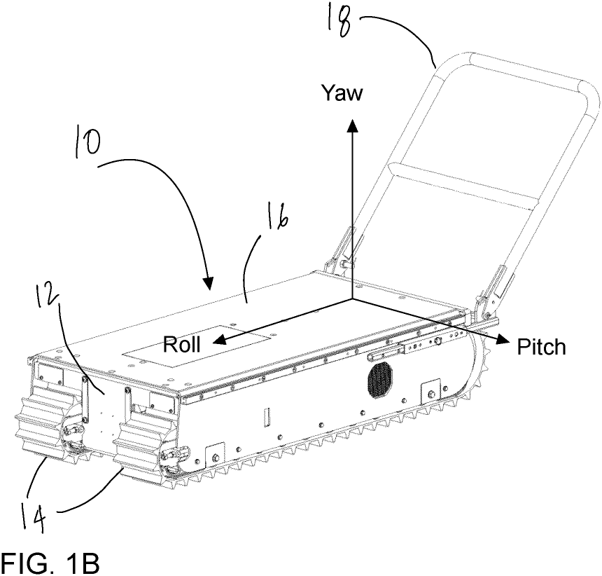

Referring to FIGS. 1A and 1B, an unmanned endless track vehicle featuring an inclination control system of the present disclosure are shown at 10. The vehicle 10 are shown having a body 12 motorized by a pair of tracks 14,but the vehicle 10 may have a single track 14. The body 12 may be viewed as the frame of the vehicle, and may enclose operational components of the vehicle 10. The body 12 encloses the motorization equipment of the endless track vehicle 10, to power the track(s) 14. The motorization equipment may be a motorization unit that includes electric motor(s), battery, a transmission, gear boxes, as well as a drive system to operate the vehicles 10, and a telecommunications unit (e.g., wireless) associated with a remote control. The vehicles 10 are used to carry loads, for instance as mounted to the top surface 16. The top surface 16 may be part of the body 12. The top surface 16 may include attachment features, such as attachment holes, anchor hoops, attachment brackets, rope rings, strap rings, etc. Handle 18 may be present, with handle 18 extending at a non-right angle relative to the top surface 16, for instance to facilitate a manipulation of the vehicle 10 during a pitch rotation. The angle may be adjusted in a variant. The vehicles 10 may be similar to that described in U.S. Pat. Application Publication No. US2005129493 for a single track, or in U.S. Pat. No. 10,494,171, both incorporated herewith by reference, and merely given as examples of endless track vehicles to carry loads. The endless track vehicle 10 of FIGS. 1A and 1B features two different endless tracks 14 with the endless tracks being selectively operable in different directions so as to allow the endless track vehicle 10 to rotate and turn. For reference, pitch, roll and yaw axes are shown in FIGS. 1A and 1B. The endless track vehicle may also have a single track 14 to move in a direction parallel to the roll axis, and may have casters to be rotated about the yaw axis. The endless track vehicles 10 may have one motor 102 or more according to different embodiments. In the embodiment of a single track, the single-track endless track vehicle 10 may have a single motor 102 and the motor 102 may be unidirectional or bidirectional. The expression “unidirectional” means that the motor 102 rotates in a single direction, whereas a bidirectional motor rotates in two directions, for forward or backward movement in a direction parallel to the roll axis. The single-track endless track vehicle may have two unidirectional motors 102 as well, one for forward movement, and another for backward movement. In another embodiment, there are two bidirectional motors 102 in the manner taught for the endless track vehicle 10 having two tracks 14, for rotation of the endless track vehicle 10 about the yaw axis. In an embodiment, the endless track vehicle 10 has independent actuation of each track 14, such that a speed differential and/or a rotation direction may be achieved between the tracks 14, to cause a rotation of the vehicle 10 about a yaw axis. Independent actuation may be achieved by each track 14 being powered by its own motor(s) 102, such as a bidirectional motor 102 per track 14, a pair of unidirection motor 102 per track 14, etc. A clutch or like transmission may alternatively or supplementaly be used to achieve independent actuation. The endless track vehicle 10 is said to be unmanned as it is designed not to have the human driver on the endless track vehicle 10 when the endless track vehicle 10 is operated. The inclination control system of the present disclosure could also be used in manned endless track vehicles.

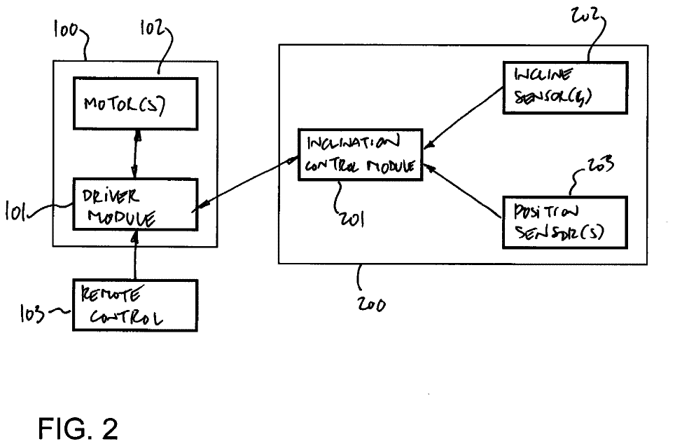

Referring to FIG. 2, a drive system of the endless track vehicles 10 is generally shown at 100. The drive system 100 is present in the endless track vehicle 10 to propel it forward and/or backward if possible, via actuation of the motor(s) 102. The drive system 100 has a processing unit featuring a drive module 101. The drive module 101 may be in the form of a non-transitory computer readable memory communicatively coupled to the processor of the drive system 100 and comprising computer readable program instructions executable by the processor for driving the motor(s) 102 of the endless track vehicles 10. As described above, the endless track vehicles 10 may have one motor 102 or more according to different embodiments. The drive system 100 operates the one or two motors 102 in the manner taught for the endless track vehicle of FIGS. 1A and 1B above.

The unmanned endless track vehicle is operated, for example, by a remote control 103. The remote control 103 may be part of the drive system 100 and may include a dedicated remote or any handheld (e.g., smart phone, tablet) or computerized equipment to give instructions to the drive module 101. This may include the possibility of driving in an autonomous mode as dictated by an operator instructing the drive system 100 to do so via the remote control 103. The remote control 103 may be wired to the drive system 100 or may operate with wireless communications. In another embodiment, the drive system 100 may be without remote control 103, and/or may have an interface on the vehicle 10 (e.g., on handle 18A or 18B) to control the vehicle 10. In another embodiment, the endless track vehicle 10 may be a self-driven vehicle, that is tasked for moving loads along uneven terrain and/or inclined surfaces.

Still referring to FIG. 2, the inclination control system 200 is coupled to the drive system 100. In an embodiment, the drive system 100 and the inclination control system 200 share a processor. In yet another embodiment, the inclination control system 200 is an add-on that serves to retrofit existing endless track vehicles 10 with inclination control. The inclination control system 200 may include non-transitory computer readable memory coupled communicatively to the processor, whether the processor be part of the drive system 100 and shared with the inclination control system 200 or dedicated to the inclination control system 200. Likewise, the non-transitory computer readable memory may be dedicated to the inclination control system 200, or may be shared or part of the drive system 100. The inclination control system 200 may further include computer readable memory program instructions executable by the processor, in the form of an inclination control module 201, for example. The inclination control system 200 may be used to monitor a behavior of the vehicle 10 relative to one or more of the pitch, roll and yaw axes, and to actively control the driving of the vehicle 10 to adjust or correct a behavior thereof. The active control may be effected in real-time or quasi-real-time. The inclination control system 200 may actively control the driving of the vehicle 10 by commanding the driver module 101 in performing given tasks, based on the type of vehicle 10 (e.g., the number of tracks 14, the number and type of motor(s) 102). In an embodiment, the inclination control system 200 actively controls the driving of the vehicle 10 in an active control mode, that may override user commands (i.e., an overriding mode), or that may be an autonomous self-driving mode of the vehicle 10. The inclination control system 200 may actively control the driving of the vehicle 10 in a collaborative mode with an operator, such as by performing automatic corrective adjustments or like automatic control maneuvers while maintaining a general command from the operator (e.g., moving forward).

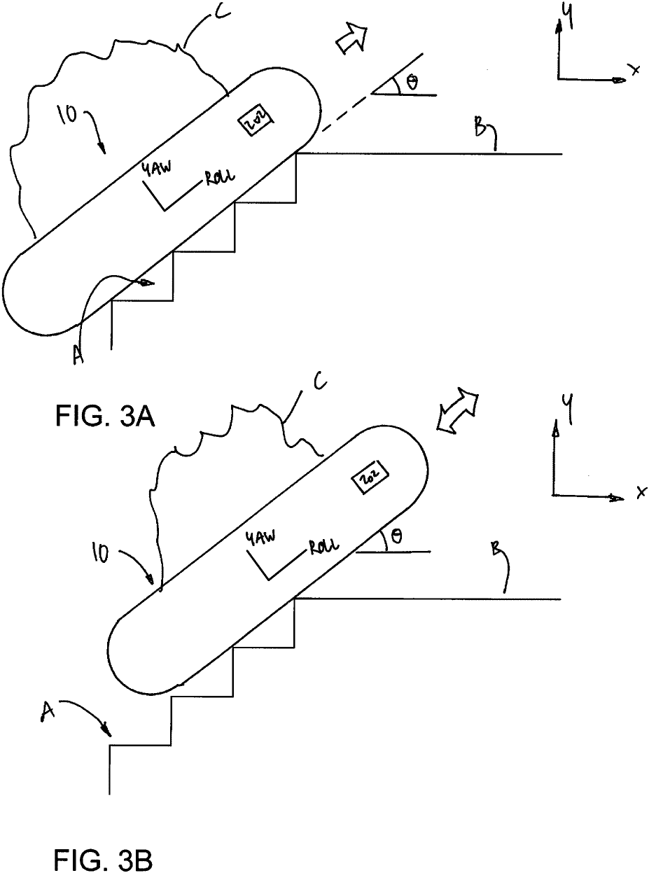

The inclination control module 201 will operate using signals from different sensors. In an embodiment, the inclination control system 200 has an incline sensor 202 or set of sensor(s) 202, that may also be known as orientation sensor(s), in that the sensor(s) 202 detect an angular variations or angular rates of change. The incline sensor(s) 202 is tasked with monitoring angular variations for different angles of the endless track vehicle 10, including at least the rotation about the pitch axis, but the incline sensor(s) 202 may alternatively or supplementaly monitor angular variations about the roll axis and/or the yaw axis. With references to FIGS. 3A and 3B, the pitch axis may be about axis Z that is normal to the plane of the page of FIGS. 3A and 3B. The inclination of the endless track vehicle 10, also known as pitch, is about the ptich axis. Rotation about the roll axis (about axis X when the endless track vehicle 10 is horizontal) and yaw axis (about axis Y when the endless track vehicle 10 is horizontal) may also be monitored by the incline sensor(s) 202, though optionally. In an embodiment, the incline sensor(s) 202 includes one or more inertial sensors as their sourceless nature is well suited for use in the inclination control system 200. For example, the incline sensor(s) 202 may include one or more of an accelerometer, a gyroscope and/or an inclinometer, or combinations thereof, or like microelectromechanical systems (MEMS). One or more of the sensors 202 may be used in conjunction with an internal clock or like time measuring feature, limit switches, etc. Therefore, angular variations over time can be indicative of angular rates of changes, i.e., angular speed and/or angular acceleration (including deceleration). It is contemplated to have numerous sensors 202 of one or more types in order to provide redundancy to the inclination control system 200. In an embodiment, the sensor(s) 202 may be located near the leading end and/or the trailing end of the endless track vehicle 10 as the leading end or trailing end of the vehicles 10 may be subject to greater acceleration than a central part of the endless track vehicle 10, and may thus be in a more sensitive psoition. It is nonetheless possible to position such sensors 202 closer to the center of the endless track vehicle 10. In an embodiment, the sensors 202 include one or more three-axes accelerometer to monitor the vehicle 10 in pitch, roll and yaw, and provide data indicative of an angular variation of the vehicle 10 along these axes. In an embodiment, the sensors 202 include one or more three-axes gyroscope to monitor the vehicle 10 in pitch, roll and yaw, and provide data indicative of an angular variation of the vehicle 10 along these axes. The inclination control module 201 may include a calibration procedure program or perform a calibration procedure, whether through operation of the vehicle 10 by an operator or a self-operate routine of movements, to calibrate the sensors 202 relative to the instant orientation of the vehicle 10, if necessary.

The inclination control system 200 may also include position sensor(s) 203. Examples of those may include an ultrasound sensor(s) and/or an optical sensor(s) that may determine distance from a leading or trailing end of the endless track vehicle 10 from a ground (e.g. stairs, stairtop, landing, floor, etc. For example, ultrasound sensor(s) are well suited to perform the position sensing considering that the vehicle 10 is always in close proximity to support surfaces and hence can echo soundwaves emitted by ultrasound sensor(s). The ultrasound sensor(s) is deemed to be an integrated solution, including an emitter and a receiver, as well as the processing circuitry to interpret echo signals. Part of the processing may also be done through the process of the inclination control system 200. As another type of position sensor(s) 203, a load cell(s) may be placed at various locations, notably on the wheel axles in order to determine whether parts of the endless track vehicle 10 are still in contact with a surface or whether they have cleared the surface as in FIG. 3B. Other types of sensors may be used as well to perform such functions. The sensors 202 and 203, if present, are communicatively coupled to the inclination control module 201 such that the inclination control module 201 receives signals from the sensors 202 and/or 203 and interprets them to determine the behavior of the endless track vehicle 10, the proximity of objects and/ or support surfaces.

Now that the various components of the inclination control system 200 have been described, an operation thereof will be shown with reference to FIGS. 3A and 3B. In FIG. 3A, the endless track vehicle 10 is shown moving up stairs A. Although stairs A are shown, the endless track vehicle 10 could also be going up an incline that is not embodied by stairs, such as a ramp, for example. A plane upon which the endless track vehicle 10 is moving can be identified as being at an angle θ from the horizon. The plane may be defined as including the tips of the stairs A, and may be referred to herein as plane of the stairs A. The horizon may be illustrated by landing B, namely a flat horizontal surface. This being said, B could be at any other angle relative to the horizon, though there is an angle variation (i.e., angle θ) between the plane of the stairs A and that of landing B (or incline B). The endless track vehicle 10 may be carrying a load C thereon.

As the endless track vehicle 10 reaches the top of the stairs A, it is on the verge of rotating substantially about the pitch axis to reach a horizontal position and lay on landing B. The object of the inclination control system 200 is to control the drive of the endless track vehicle 10 with load C so as to limit the angular speed of the endless track vehicle 10 about the pitch axis, so as to avoid high impact of the front end of the endless track vehicle 10 hitting the landing B. This may be referred to as an inclination control mode or pitch control mode, in which the inclination control system 200 takes control of the driving of the motor(s) 102. In an embodiment, it may be the operator of the drive system 100 that indicates to the drive system 100 that it must go into the inclination control mode. In an another embodiment, the switch to the inclination control mode may be automatically activated by the inclination control system 200, for instance after noticing that the endless track vehicle 10 has reached the position of FIG. 3B, for example via the position sensor(s) 203. For example, an ultrasound sensor(s) 203 at a leading end of the endless track vehicle 10 may provide suitable signals for the inclination control module 201 to determine that the leading end of the endless track vehicle 10 has gone beyond the transition point between the planes (or surfaces) A and B. The inclination control system 200 may also determine that the endless track vehicle 10 has reached the position of FIG. 3B, from obtaining signals from the incline sensor(s) 202, for instance by noting an angular speed or angular acceleration beyond a given threshold. In these circumstances, the inclination control system 200 determines that the endless track vehicle 10 has reached a tipping point (a.k.a., inflection point) and that the inclination control mode must be activated.

In the inclination control mode, the incline sensor(s) 202 provide(s) signals to the inclination control module 201 for the inclination control module 201 to calculate the angular speed of the vehicle about the pitch axis and/or angular acceleration. The inclination control module 201 may be programmed with speed or acceleration thresholds that must not be exceeded. As an alternative or additional possibility, the position sensor(s) 203 provide(s) signals to the inclination control module 201 for the inclination control module 201 to determine a distance of the vehicle 10 from surface B of from a transition point between A and B. The inclination control module 201 may be programmed with distance thresholds that must not be exceeded. While monitoring the angular speed/acceleration about the pitch axis, the inclination control module 201 may be in communication with the drive module 101 to control the motor(s) 102 in an appropriate way. In the instance in which the endless track vehicle 10 has a single unidirectional motor 102, the inclination control module 201 may operate the drive module 101 to decelerate the forward velocity of the endless track vehicle 10. When the endless track vehicle 10 is equipped with bidirectional motors 102 and/or has the capacity of moving forward and backward, the inclination control module 201 may communicate with the drive module 101 for the drive module 101 to decelerate the forward velocity, and cause a rearward movement of the endless track vehicle 10 via the motor(s) 102, for example when a threshold is reached. Therefore, this fine tuning of movement, and slow speeds and/or reversal, may allow a slower approach to a tipping point by which the endless track vehicle 10 will rotate about the pitch axis. This therefore allows a control of the angular speed of rotation about the pitch axis, especially limiting the pitch rotation to a low angular speed of rotation, and/or a control of the acceleration. The endless track vehicle 10 may thus move along the stairs A at a higher velocity, to then reach a lower velocity and/or reciprocating backward/forward movement at or near the position illustrated in FIG. 3B. The lower velocity may be upon detection of a position from signals of the position sensor(s) 203, or by detection of a rate of angular variation (e.g, any component of acceleration) from signals of the incline sensor(s) 202.

A similar approach may be taken when the endless track vehicle 10 is on the landing B and is on the verge of going to the steps of the staircase A. Again, the inclination control module 201 may operate the inclination control mode to control movement of the endless track vehicle 10 in transitioning through the tipping point and cause a deceleration or control of the angular speed to avoid high impacts of the endless track vehicle 10 with load C as it rotates to come into contact with the stairs A.

In the stairs scenario, the inclination control system 200 may also control the drive of the endless track vehicle 10 with load C so as to detect any deflection of the vehicle 10 from a straight line movement down or up the stairs, by monitoring angular variations about the yaw axis. An angular variation of the endless track vehicle 10 about the yaw axis may indicate that the endless track vehicle 10 has deviated from its straight line trajectory. For example, the endless track vehicle 10 of the type having two tracks 14 may experience a yaw shift, for instance if one of the two tracks 14 loses traction, due to the limited contact between the tracks 10 and the stair noses. In the instance in which the endless track vehicle 10 has unidirectional motors 102, the inclination control module 201 may operate the drive module 101 to decelerate or stop the forward velocity of one of the tracks 14 relative to the other to return the vehicle 10 to a desired yaw orientation. When the endless track vehicle 10 is equipped with bidirectional motors 102 for each track 14 and/or has the capacity of moving forward and backward, the inclination control module 201 may communicate with the drive module 101 for the drive module 101 to decelerate the forward velocity, and optionally cause a rearward movement of one of the two tracks 14 to cause a rotation about the yaw axis and return the endless track vehicle 10 to the original path of movement. Once attained, the inclination control module 201, for instance in a control loop, may control the drive module 101 for the drive module 101 to resume equal drive of the tracks 14.

In an uneven terrain scenario, or a sloped terrain scenario, a variation of orientation of the vehicle 10 about the roll axis may be a possibility. The inclination control system 200 may also control the drive of the endless track vehicle 10 with load C so as to detect any risk of rollover of vehicle 10 moving forward in a straight line movement or along an arcuate path, by monitoring angular variations about the roll axis. An angular variation of the endless track vehicle 10 about the roll axis may increase a risk of rollover of the endless track vehicle 10, considering that the load C has elevated a center of mass of the assembly. If the orientation of the endless track vehicle 10 about the roll axis is above a given threshold, the inclination control module 201 may operate the drive module 101 to decelerate the vehicle 10 and lower the forward velocity (i.e., in a direction parallel to the roll axis) of the track(s) 14. Alternatively, the inclination control module 201 may limit the velocity of the vehicle 10. The inclination control module 201 may continuously monitor the roll of the vehicle 10, and may consequently control the drive module 101 for the drive module 101 to resume operation of the vehicle 10 without speed limit when the rollover risk has reduced.

The systems 100 and/or 200 may define a system for controlling a pitch of an endless track vehicle that include one or more processors and a non-transitory computer readable memory communicatively coupled to the processor of the drive system and comprising computer readable program instructions executable by the processor for: driving the endless track vehicle in a given direction; monitoring a pitch angle of the endless track vehicle while moving along the given direction; upon determining that the pitch angle is varying, controlling the driving of the endless track vehicle to control a rate of variation of the pitch angle. The system may decelerate a velocity of the vehicle in the given direction; drive the vehicle backward.

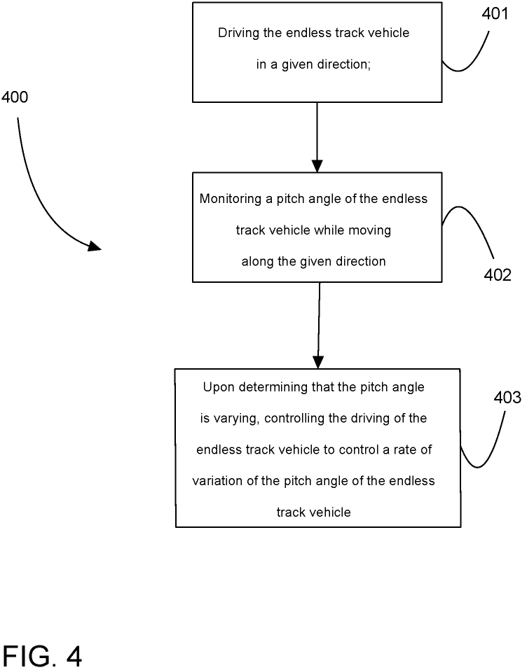

Referring to FIG. 4, an exemplary method for controlling a pitch of an endless track vehicle, such as the endless track vehicle 10, is generally shown at 400. The method 400 is performed by the endless track vehicle 10 or by a processor for instace in the form of non-transitory computer readable memory communicatively coupled to the processor of the drive system and comprising computer readable program instructions embodied partly or jointly by the inclination control system 200. The method 400 may include a step 401 of driving the endless track vehicle in a given direction; a step 402 of monitoring a pitch angle of the endless track vehicle while moving along the given direction; a step 403 of controlling the driving of the endless track vehicle to control a rate of variation of the pitch angle of the endless track vehicle, upon determining that the pitch angle is varying. Steps 401 and 402 may occur concurrently. Steps 402 and 403 may occur concurrently or overlap. Steps 401 and/or 402 may resume after step 403. In some examples, other steps or substeps may include: controlling the driving of the endless track vehicle includes decelerating a velocity of the endless track vehicle in the given direction; controlling the driving of the endless track vehicle includes driving the endless track vehicle in a direction opposite to the given direction; driving the endless track vehicle in a given direction includes driving the endless track vehicle along a stair case or landing of a stair case; monitoring a position of the endless track vehicle relative to a transition between the stair case and the landing; controlling the driving of the endless track vehicle to decelerate the endless track vehicle when a distance from the transition is reached; monitoring the position of the endless track vehicle is performed by ultrasound sensing; monitoring a yaw of the endless track vehicle while moving along the given direction along the stair case; upon determining that the yaw is varying, controlling the driving of the endless track vehicle to adjust the yaw of the endless track vehicle; controlling the driving of the endless track vehicle to adjust the yaw of the endless track vehicle includes inducing a speed differential between two tracks of the endless track vehicle; controlling the driving of the endless track vehicle to adjust the yaw of the endless track vehicle includes inducing a difference in direction of rotation between two tracks of the endless track vehicle; monitoring a roll of the endless track vehicle while moving along the given direction; upon determining that the roll of the endless track vehicle is at a threshold, controlling the driving of the endless track vehicle to decelerate the endless track vehicle; wherein, upon determining that the roll of the endless track vehicle is at a threshold, controlling the driving of the endless track vehicle to limit a top velocity of the endless track vehicle; or any suitable combination of such steps. In some instances, the driving, the monitoring and the controlling of the driving are performed in an autonomous self-driving mode of the endless track vehicle; the driving, the monitoring and the controlling of the driving are performed in overriding mode of the endless track vehicle to override operator commands; the driving, the monitoring and the controlling of the driving is performed automatically.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A system for controlling a pitch of an endless track vehicle comprising:
one or more processors;
a non-transitory computer readable memory communicatively coupled to the processor of the drive system and comprising computer readable program instructions executable by the processor for:
driving the endless track vehicle in a given direction;
monitoring a pitch angle of the endless track vehicle while moving along the given direction; and
upon determining that the pitch angle is varying, controlling the driving of the endless track vehicle to control a rate of variation of the pitch angle of the endless track vehicle.

2. The system according to claim 1, wherein controlling the driving of the endless track vehicle includes decelerating a velocity of the endless track vehicle in the given direction.

3. The system according to claim 1, wherein controlling the driving of the endless track vehicle includes driving the endless track vehicle in a direction opposite to the given direction.

4. The system according to claim 1, wherein driving the endless track vehicle in a given direction includes driving the endless track vehicle along a stair case or landing of a stair case.

5. The system according to claim 4, further including monitoring a position of the endless track vehicle relative to a transition between the stair case and the landing.

6. The system according to claim 5, further including controlling the driving of the endless track vehicle to decelerate the endless track vehicle when a distance from the transition is reached.

7. The system according to claim 5, wherein monitoring the position of the endless track vehicle is performed by ultrasound sensing.

8. The system according to claim 4, including monitoring a yaw of the endless track vehicle while moving along the given direction along the stair case.

9. The system according to claim 8, wherein, upon determining that the yaw is varying, controlling the driving of the endless track vehicle to adjust the yaw of the endless track vehicle.

10. The system according to claim 9, wherein controlling the driving of the endless track vehicle to adjust the yaw of the endless track vehicle includes inducing a speed differential between two tracks of the endless track vehicle.

11. The system according to claim 9, wherein controlling the driving of the endless track vehicle to adjust the yaw of the endless track vehicle includes inducing a difference in direction of rotation between two tracks of the endless track vehicle.

12. The system according to claim 1 including monitoring a roll of the endless track vehicle while moving along the given direction.

13. The system according to claim 12, wherein, upon determining that the roll of the endless track vehicle is at a threshold, controlling the driving of the endless track vehicle to decelerate the endless track vehicle.

14. The system according to claim 12, wherein, upon determining that the roll of the endless track vehicle is at a threshold, controlling the driving of the endless track vehicle to limit a top velocity of the endless track vehicle.

15. The system according to claim 1 wherein the driving, the monitoring and the controlling of the driving are performed in an autonomous self-driving mode of the endless track vehicle.

16. The system according to claim 1, wherein the driving, the monitoring and the controlling of the driving are performed in overriding mode of the endless track vehicle to override operator commands.

17. The system according to claim 1, wherein the driving, the monitoring and the controlling of the driving are performed automatically.

18. The system according to claim 1, further including at least one orientation sensor.

19-20. (canceled)

21. The system according to claim 1, further including at least one position sensor.

22. (canceled)

23. An endless track vehicle comprising:
a body defining a load bearing surface;
at least one track rotatably mounted to the body to move the body;
a motorization unit to actuate the at least one track;
a drive system to operate the motorization unit; and
the system according to claim 1, the system collaborating with the drive system.

24-25. (canceled)
